(19) United States
(12) Patent Application Publication
(10) Pub. No.: US 2006/0219357 A1
(43) Pub. Date: Oct. 5, 2006

(54) Pipe manufacturing method and inner pipe of double pipe

(76) Inventors: Takayasu Isono, Toyota-shi (JP); Masatsune Kondo, Okazaki-shi (JP); Yasuhiro Nobata, Toyota-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/385,845

(22) Filed: Mar. 22, 2006

(30) Foreign Application Priority Data
Mar. 22, 2005 (JP) 2005-82240

(51) Int. Cl. B32B 38/00; F01N 7/08; B32B 37/00

(52) U.S. Cl. 156/292; 156/196

(57) ABSTRACT

The present invention suggests a pipe manufacturing method by new plastic bonding with high bonding power and adopted to a thin pipe.

With regard to the pipe manufacturing method that bonding fins 3a and 3b are provided at edges 2a and 2b of plural split pipes 2A and 2B split along longer direction and the split pipes 2A and 2B are united by caulking the bonding fins 3a and 3b of the split pipes 2A and 2B, the bonding fin 3a is wound around the other bonding fin 3b for caulking them so as to form creases 35 circularly centering on an axis of the roll form.

### FIELD OF THE INVENTION

The present invention relates to a pipe constructed by engaging edges of plural split pipes split along a lengthwise direction. In more detail, the present invention relates to a method for constructing a pipe by caulking a pair of bonding fins.

### DESCRIPTION OF THE RELATED ART

Conventionally, various arts have been suggested concerning the assembly construction of a pipe constructed by engaging edges of a pair of half members. There is some literature disclosing the assembly construction of a piping for an exhaust system of an engine, such as a casing of an exhaust manifold or muffler (for example, see patents 1 and 2 below).

The below-listed patents disclose arts of plastic bonding in which a pair of bonding fins are provided at edges of a pair of half members respectively and the bonding fins are put together and caulked so as to unite the pair of half members.

[Patent 1] Japanese Patent Laid Open Gazette Hei. 9-125948

[Patent 2] Japanese Patent Laid Open Gazette 2000-88150

### SUMMARY OF THE INVENTION

The above-mentioned plastic bonding by caulking the bonding fins may be adopted instead of weld bonding in consideration of the necessity of skill and working environment for the conventional weld bonding. However, the bonding power of plastic bonding is lower than that of weld bonding.

On the other hand, with regard to the weld bonding, in the case of a thin pipe whose thickness is 0.8 mm or less for example, a weld pool which can be kept by surface tension is small, so that a gap produced between the edges of the half members put together cannot be bridged. Accordingly, weld bonding a thin pipe is more difficult compared to weld bonding a thick pipe.

Such a thin pipe is used as an inner pipe of an exhaust system of an engine having a dual construction for example. In this field, further reduction of thickness is required in consideration of the improvement of exhaust ability of the LEV (Low Emission Vehicle) in recent years.

The reduction of thickness reduces heat capacity of an exhaust pipe so as to reduce quantity of heat taken from exhaust gas to the exhaust pipe, whereby exhaust gas with higher temperature can be supplied to a catalyzer. Especially, initial emission is improved.

In consideration of the above-mentioned problems, the present invention suggests a pipe manufacturing method by new plastic bonding with high bonding power and which is adapted to a thin pipe.

The above-mentioned problems are solved by the following means according to the present invention.

Bonding fins are provided at edges of plural split pipes split along a lengthwise direction and the split pipes are united by caulking the bonding fins of the split pipes, one of the bonding fins being wound around the other bonding fin prior to caulking them so as to form creases arcuately centering on an axis of a roll form.

The bonding fins are pinched between holders while the bonding fins are put together, and a punch, on which a groove facing end surfaces of the bonding fins is formed, punches the bonding fins from the projected ends thereof for rolling the bonding fins along the sectional form of the groove prior to caulking the bonding fins.

Preferably, the sectional form of the groove of the punch is substantially semicircular.

Projected ends of the bonding fins are bent previously along the roll direction by the punch, and by punching the punch horizontally against the surface of the bonding fins, the bonding fins are rolled along the bent direction.

A projection width of one of the bonding fins, which is disposed outwardly after caulking the bonding fins, from the split pipe is longer than a projection width of the other bonding fin, which is disposed inwardly after caulking the bonding fins, from the split pipe so that the substantial whole inward bonding fin is rolled by the outward bonding fin.

Peripheral lengths in the lengthwise direction of the end surfaces of the projected ends of the bonding fins differ from each other.

An outline in plan view of an end surface of the bonding fin, arranged externally after caulking the bonding fins, is substantially arcuate.

In another embodiment, the groove of the punch is hollow arc-shaped in sectional plan view whose center is hollowed in the lengthwise direction.

Preferably, the thickness of the split pipes is 0.8 mm or less.

An inner pipe of a double pipe constituting an exhaust system of an internal combustion engine includes bonding fins provided at edges of plural split pipes split along the lengthwise direction so that the split pipes are united by caulking the bonding fins of the split pipes, one of the bonding fins being wound around the other bonding fin prior to caulking them so as to form creases arcuately centering on an axis of the roll form.

The bonding fins are engaged with each other by the creases, whereby high bonding power is obtained. Since the creases are formed arcuately centering on the axis of the roll form on the bonding fins, high bonding power is obtained especially against the load along the axis of the roll form.

The roll form can be formed along a desired direction.

The contact area between the bonding fins can be kept broadly so as to obtain high bonding power.

The creases are formed certainly.

The present invention can be adapted to the bonding of a pipe formed from a thin plate, to which weld bonding is difficult to be adapted.

The inner pipe can be constructed from a thin plate so that the heat capacity of the inner pipe is small, thereby improving the initial emission.

### BRIEF DESCRIPTION OF THE DRAWINGS

FIG. 1 is a drawing of a construction of a pipe manufactured by a pipe manufacturing method according to the present invention.

FIG. 2 is a drawing of an example of an application of the pipe as an inner pipe of a double pipe exhaust manifold constituting an exhaust system of an internal combustion engine.

FIG. 3 is a plan view of bonding fins of a caulked part at the curved part of the piping.

FIG. 4 is a perspective view of a punch and the bonding fins.

FIG. 5 is a schematic drawing depicting formation of a roll form by using the punch.

FIG. 6 is a drawing of a circular arc-shaped groove of the punch.

FIG. 7 is a drawing of creases formed on the caulked part.

FIG. 8 is a drawing of a straight line-shaped groove of the punch.

FIG. 9 is a drawing of the construction with the end surface of the inner bonding fin being a straight line.

FIG. 10 is a plan view of the bonding fins of the caulked part at the straight part of the pipe.

FIG. 11(a) is a drawing of an embodiment in which the pipe is constructed from split pipes formed by press molding two plate materials respectively.

FIG. 11(b) is a drawing of an embodiment in which the pipe is constructed by bending split pipes formed by press molding from a single plate material.

### PREFERRED EMBODIMENT OF THE INVENTION

A preferred embodiment of the present invention will be explained with reference to the accompanying drawings.

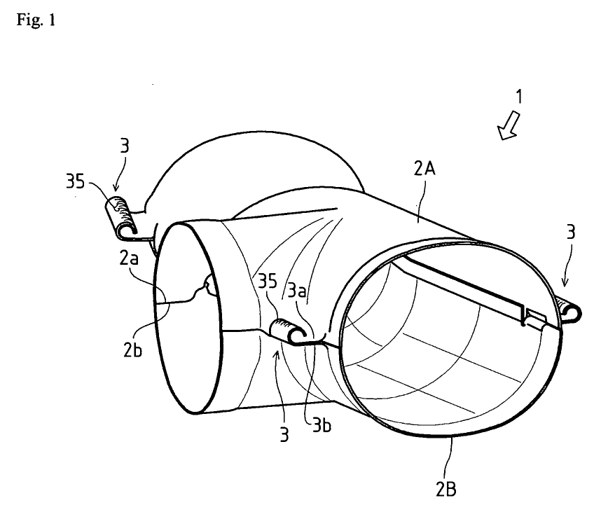

FIG. 1 shows a pipe 1 to which the assembly construction according to the present invention is adapted.

The pipe 1 comprises split pipes 2A and 2B split along a lengthwise direction, and bonding fins 3a and 3b is provided at edges 2a and 2b of the split pipes 2A and 2B. By caulking the bonding fins 3a and 3b of the split pipes 2A and 2B, the split pipes 2A and 2B are united. By winding the bonding fins 3a around the bonding fins 3b prior to caulking them, creases 35 are formed arcuately centering on an axis of a roll form.

With regard to this construction, the caulked parts 3 are formed by caulking the bonding fins 3a and 3b. The split pipes 2A and 2B are bonded plastically (caulked) by the caulked parts 3.

The pipe 1 is manufactured by a pipe manufacturing method that the bonding fins 3a and 3b are provided at the edges 2a and 2b of the split pipes 2A and 2B split along the lengthwise direction and the split pipes 2A and 2B are united by caulking the bonding fins 3a and 3b of the split pipes 2A and 2B, wherein the creases 35 are formed arcuately centering on the axis of the roll form by winding the bonding fins 3a around the bonding fins 3b prior to caulking them.

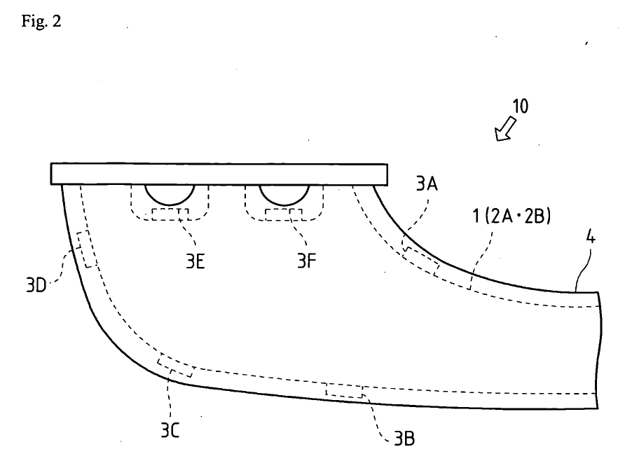

As shown in FIG. 2 for example, the pipe 1 is adopted as an inner pipe of a double pipe exhaust manifold 10 constituting an exhaust system of an internal combustion engine. In this construction, the split pipes 2A and 2B are not welded for bonding without the parts bonded plastically by caulked parts 3A to 3F. Air leaking through the gap between the edges 2a and 2b of the split pipes 2A and 2B is prevented from leaking outside by making an outer pipe 4 airtight.

As shown in FIG. 2, the caulked parts 3A to 3F are arranged suitably at plural positions so as to prevent the split pipes 2A and 2B from being separated.

Some caulked parts are arranged at curved parts of the pipe 1 as the caulked parts 3A and 3C, and some caulked parts are arranged at substantial straight parts of the pipe 1 as the caulked parts 3B, 3D, 3E and 3F. The assembly construction according to the present invention is adapted to all of the caulked parts.

Hereinafter, explanation will be given in detail on the construction of each of the caulked parts 3.

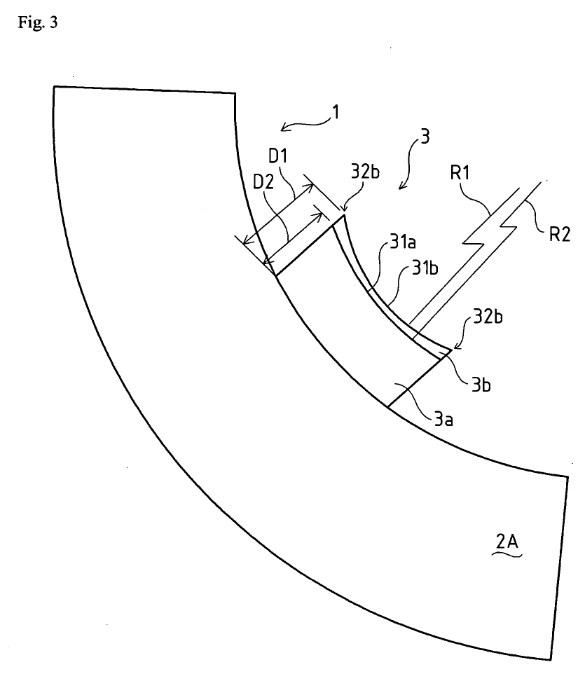

As shown in FIGS. 3 to 5, the bonding fins 3a and 3b are respectively provided on the split pipes 2A and 2B projecting outwardly along the radial direction of the pipe.

Then, the bonding fins 3a and 3b are pinched between holders 25 and 26 while the bonding fins 3a and 3b are put together. A punch 20, on which a groove 21 facing the end surfaces 31a and 31b of the bonding fins 3a and 3b is formed, punches the bonding fins 3a and 3b at the projected ends thereof so as to roll the bonding fins 3a and 3b along the sectional form of the groove 21. Accordingly, the caulked part 3 is constructed.

Preferably, the groove 21 of the punch 20 is substantially semicircular in cross-section so that the outer bonding fin 3b is wound around the inner bonding fin 3a by punching the punch 20.

Following the formation of the roll form, the creases 35 are formed arcuately centering on the axis CL of the roll form on the bonding fins 3a and 3b.

By the creases 35, the bonding fins 3a and 3b are engaged with each other, whereby high bonding power is obtained. Since the creases 35 are formed arcuately (rectangularly to the arc) centering on the axis CL of the roll form on the bonding fins 3a and 3b, high bonding power is obtained especially against the load along the axis CL of the roll form.

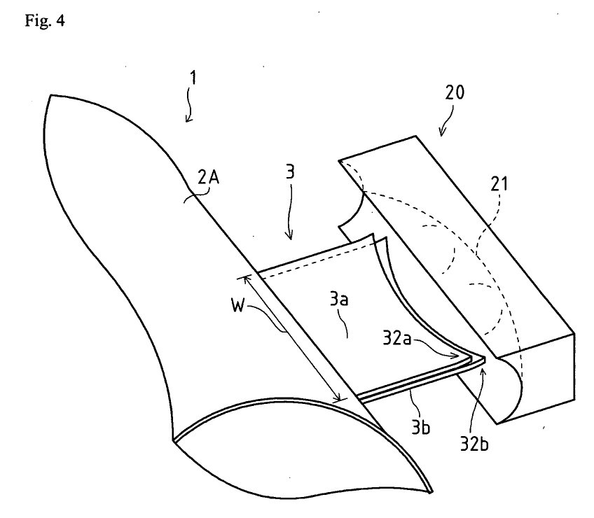

As shown in FIG. 4, the projected ends of the bonding fins 3a and 3b are slightly bent previously along the roll direction by the punch 20. Therefore, by punching with the punch 20 horizontally against the surface of the bonding fins 3a and 3b, the bonding fins 3a and 3b are rolled along the bent direction. Accordingly, the roll form can be formed along the desired direction.

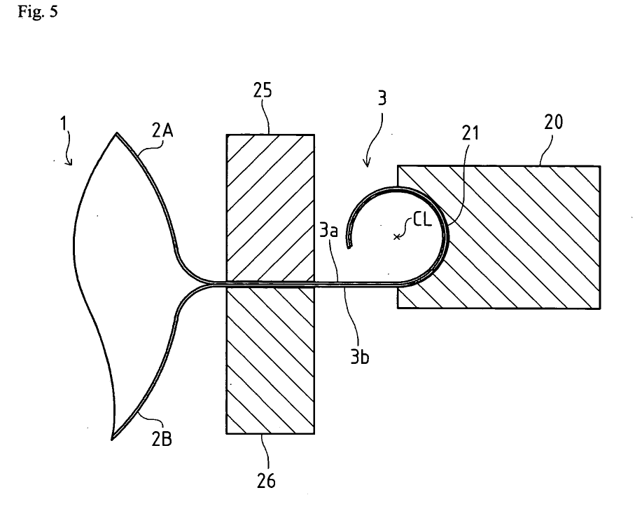

As shown in FIG. 3, the projection width D1 of the bonding fin 3b, disposed outwardly after caulking the bonding fins 3a and 3b, from the split pipe 2A is longer than the projection width D2 of the bonding fin 3a, disposed inwardly after caulking the bonding fins 3a and 3b, from the split pipe 2B. As shown in FIG. 5, the substantial whole inner bonding fin 3a is rolled by the outer bonding fin 3b. Accordingly, the contact area between the bonding fins 3a and 3b can be kept broadly so as to obtain high bonding power.

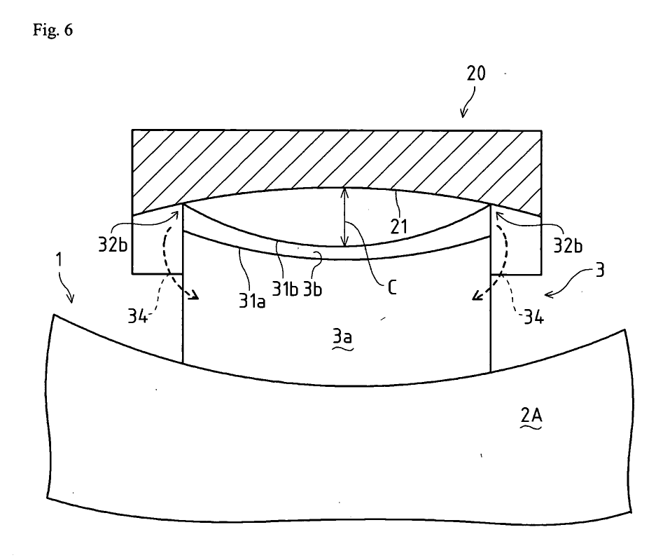

As shown in FIGS. 3 and 6, the peripheral lengths in the lengthwise direction of the end surfaces 31a and 31b of the projected ends of the bonding fins 3a and 3b differ from each other.

In this embodiment, the lateral width W is common between the bonding fins 3a and 3b. The outline of each of the bonding fins 3a and 3b in plan view is a hollow arc whose lateral center is hollowed. The radius R1 of the arc of the bonding fin 3b arranged outwardly after caulking the bonding fins 3a and 3b is set smaller than the radius R2 of the arc of the bonding fin 3a arranged inwardly so that the peripheral length of the end surface 31b is longer than that of the end surface 31a.

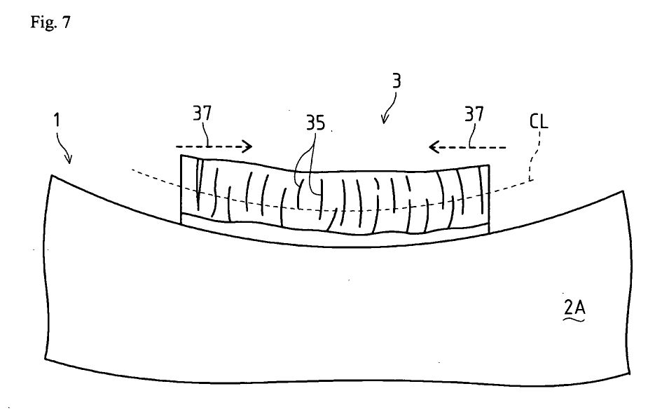

As shown in FIG. 7, by making the peripheral lengths of the end surfaces 31a and 31b differ from each other as the above, the creases 35 rectangular to the arc of the bonding fins 3a and 3b (circular centering on the axis CL of the roll form) are formed certainly on the bonding fins 3a and 3b following punching the punch 20.

The creases 35 are formed by the plastic deformation of the bonding fins 3a and 3b. Even if the peripheral lengths of the end surfaces 31a and 31b are the same, the creases 35 are also formed. However, by making the peripheral lengths of the end surfaces 31a and 31b differ from each other purposely, the creases 35 are formed more certainly.

By the creases 35, the bonding fins 3a and 3b are engaged with each other, thereby obtaining high bonding power. Since the creases 35 are formed arcuately (rectangularly to the arc) centering on the axis CL of the roll form on the bonding fins 3a and 3b, high bonding power is obtained especially against the load along the axis CL of the roll form.

In addition, what is necessary is just to make the peripheral lengths of the end surfaces 31a and 31b differ from each other, and the difference may be opposite to this embodiment, that is, the peripheral length of the end surface 31a may be longer than that of the end surface 31b.

As shown in FIG. 6, the outline in plan view of the end surface 31b of the bonding fin 3b arranged outwardly after caulking the bonding fins 3a and 3b is arcuate so that corners 32b of the end surface 31b firstly touch the groove 21 of the punch 20. Accordingly, load is applied on the bonding fin 3b along arrows 34, that is, along the direction from the corners 32b of the arc to the middle point of the arc so as to contract the length of the arc.

Then, as shown in FIG. 7, the load makes the bonding fin 3b bend along arrows 37, whereby the formation of the creases 35 is promoted.

Accordingly, by forming the creases 35, higher bonding power is obtained.

As shown in FIGS. 4 and 6, the groove 21 of the punch 20 is hollow arc-shaped in sectional plan view whose center is hollowed in the longer direction (lateral direction).

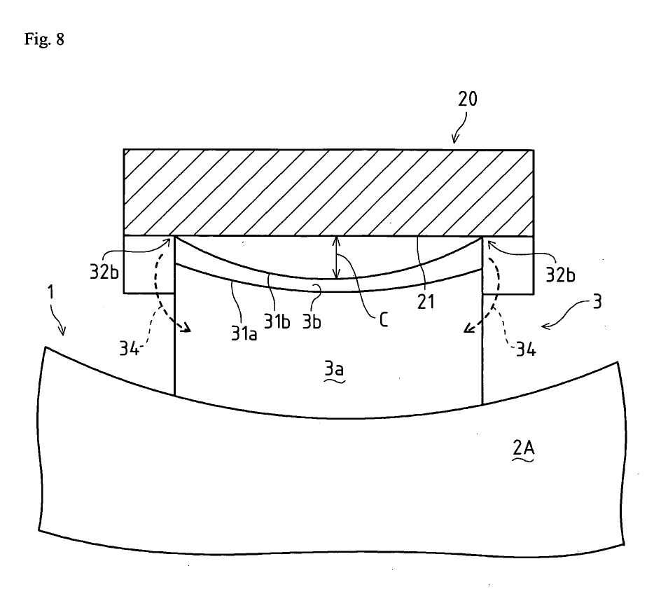

Accordingly, as shown in FIG. 8, compared with the case that the groove 21 of the punch 20 is straight line-shaped, the clearance C between the groove 21 and the center of the end surface 31b of the bonding fin 3b is secured wider. By securing the clearance C wider, the section in which the groove 21 acts only on the corners 32b is kept long in the process of punching the punch 20, whereby the section in which the load of the arrows 34 occurs is secured long.

Accordingly, the load of the arrows 34 occurs more certainly, whereby the formation of the creases 35 is promoted.

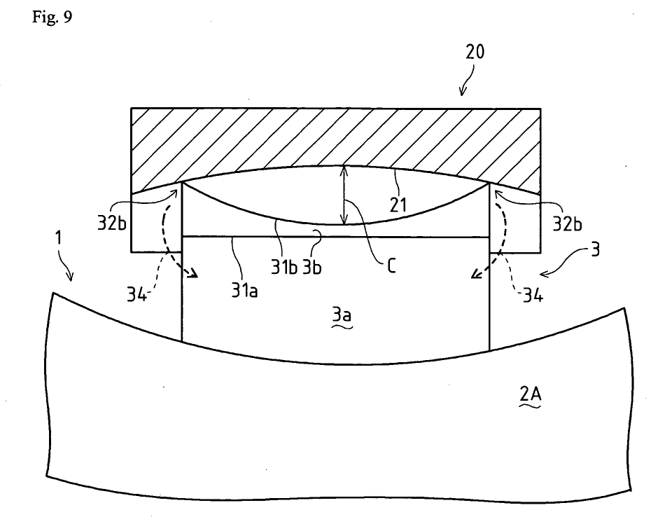

As shown in FIG. 9, by making the outline in plan view of the end surface 31b of the bonding fin 3b arranged outwardly arc-shaped, the same effect can be obtained even if the outline in plan view of the end surface 31a of the bonding fin 3a arranged inwardly is straight line-shaped.

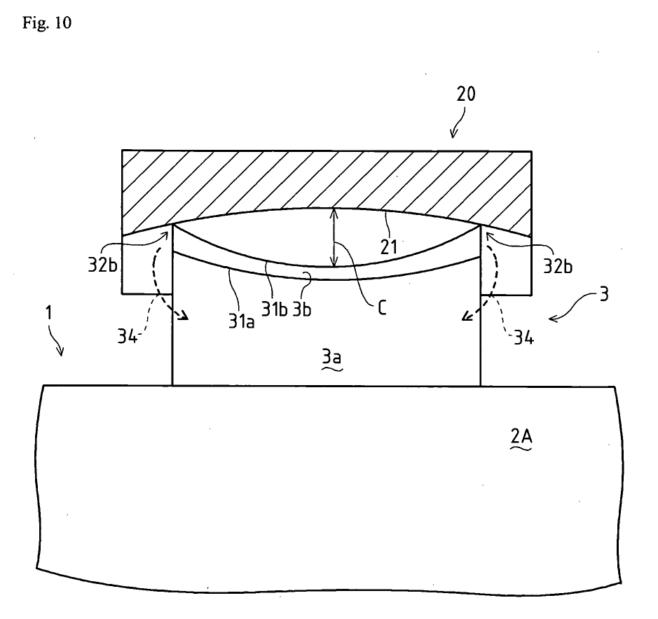

The caulked part 3 formed at the curved part of the pipe 1 as shown in FIG. 3 has been explained above. However, the above-mentioned construction also can be adopted to the caulked part 3 formed at the straight part of the pipe 1 as shown in FIG. 10 so as to obtain the same effect.

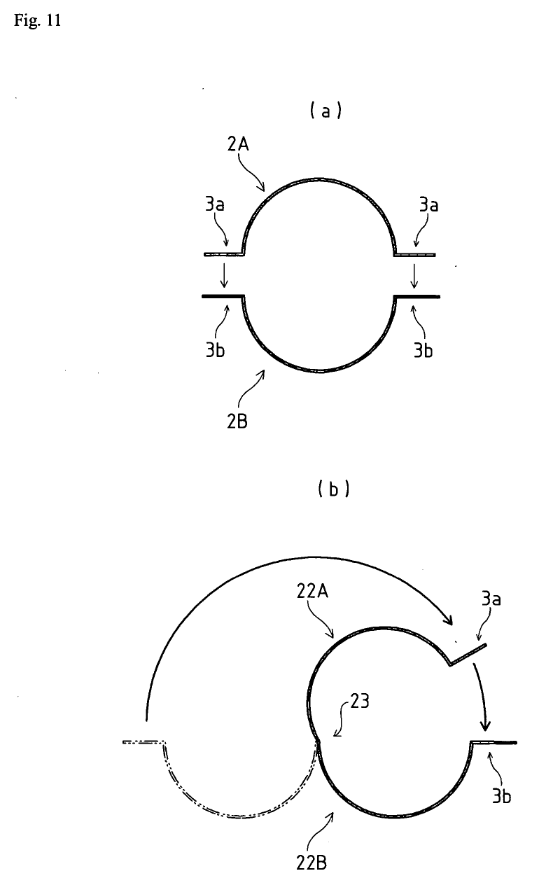

As shown in FIG. 11 (a), the split pipes 2A and 2B may be formed by press molding from two plate materials respectively. Alternatively, as shown in FIG. 11 (b), the split pipes 2A and 2B may be formed that half pipes 22A and 22B are formed by press molding from one plate material and are bent at a bending part 23 so as to put the bonding fins 3a and 3b of the half pipes 22A and 22B together. The assembly construction according to the present invention can be adapted to each of the modes of split pipes in FIGS. 11 (a) and (b). The pipe may be split into two, three or four, and the number of split pipes is not limited. Accordingly, the method can be adopted to the plastic bonding of parts with high number of split pipes so as to construct more complicated form of piping.

With regard to the above embodiment, the sectional forms of the split pipes 2A and 2B are substantially semicircular. However, the present invention also can be adapted to a pipe with a square section comprising split pipes with substantial angular U-shaped sections. The forms of the split pipes 2A and 2B are not limited.

The above construction is especially suitable for the case wherein the split pipes 2A and 2B, molded from a thin plate, whose thickness is 0.8 mm or less, are caulked. It is proved by experiment that the creases 35 are formed by the above-mentioned plastic bonding with a stainless steel plate material whose thickness is 0.4 mm. In addition, physical properties of the stainless steel plate are that Young's modulus is 206 GPa, the yield point is 0.254 MPa, and the tensile strength is 0.637 MPa.

By constructing the pipe 1 from such a thin material as the above mentioned so as to adopt the thin pipe 1 as the inner pipe of the double pipe as shown in FIG. 2, the heat capacity of the inner pipe is small, thereby improving the initial emission.

1. A pipe manufacturing method that comprising:
providing bonding fins at edges of plural split pipes split along a lengthwise direction; and
uniting the split pipes by caulking the bonding fins of the split pipes, wherein
one of the bonding fins is wound around the other bonding fin prior to caulking them so as to form creases circularly centering on an axis of a roll form.

2. A pipe manufacturing method as set forth in claim 1, further comprising:
pinching the bonding fins between holders while the bonding fins are put together, and
providing a punch, said punch including a groove facing to end surfaces of the bonding fins, and punching the bonding fins at projected ends thereof, for rolling the bonding fins along a sectional form of the groove of the punch prior to caulking the bonding fins.

3. A pipe manufacturing method as set forth in claim 2, wherein the sectional form of the groove of the punch is substantially semicircular.

4. A pipe manufacturing method as set forth in claim 2 further comprising:
bending the projected ends of the bonding fins previously along a roll direction by the punch, and punching with the punch horizontally against a surface of the bonding fins, thereby rolling the bonding fins along the roll direction.

5. A pipe manufacturing method as set forth in claim 1, wherein
a projection width of one of the bonding fins, disposed outwardly of the other bonding fin after caulking the bonding fins, from the split pipe is longer than a projection width of the other bonding fin, disposed inwardly of the one bonding fin after caulking the bonding fins, from the split pipe so that the substantial whole inwardly-disposed bonding fin is rolled by the outwardly-disposed bonding fin.

6. A pipe manufacturing method as set forth in claim 1, wherein
peripheral lengths in the lengthwise direction of end surfaces of projected ends of the bonding fins differ from each other.

7. A pipe manufacturing method as set forth in claim 1, wherein
an outline in plan view of an end surface of an outwardly-disposed bonding fin, arranged after caulking the bonding fins, is substantially arcuate.

8. A pipe manufacturing method as set forth in claim 2, wherein
the groove of the punch is substantially arcuate in sectional plan view having a center hollowed in the lengthwise direction.

9. A pipe manufacturing method as set forth in claim 1, wherein
a thickness of the split pipes is 0.8 mm or less.

10. An inner pipe of a double pipe constituting an exhaust system of an internal combustion engine, comprising
bonding fins provided at edges of plural split pipes split along a lengthwise direction so that the split pipes are united by caulking the bonding fins of the split pipes, wherein
one of the bonding fins is wound around the other bonding fin prior to caulking them so as to form creases arcuately centering on an axis of a roll form.
